(19) United States
(12) Patent Application Publication
(10) Pub. No.: US 2005/0141611 A1
(43) Pub. Date: Jun. 30, 2005

(54) Transmission of stuffing information for transmission of layered video streams

(76) Inventors: Daniel Snook, Paris (FR); Yves Ramanzin, Paris (FR)

Correspondence Address: Philips Electronics North America Corporation;Corporate Patent Counsel, PO Box 3001, Briarcliff Manor, NY, 10510, US

(21) Appl. No.: 10/504,050

(22) PCT Filed: Feb. 12, 2003
(86) PCT No.: PCT/IB03/00566

(30) Foreign Application Priority Data
Feb. 12, 2002 (FR) 02/01720

(51) Int. Cl. H04N 7/12

(52) U.S. Cl. 375/240.15; 375/240.01; 375/240.12

(57) ABSTRACT

The invention relates to encoding of an input sequence of digital images delivering a base and an enhancement layer bitstream for transmission of video data in real time over a fluctuating-rate transmission channel. The method distributes the encoded data for the images of said sequence between two subsequences of base and an enhancement layer and evaluates degree of occupation of two associated buffers. A notional (virtual, dummy) bi-directional image is created in one of the subsequences which is intended to receive stuffing data, when the degree of occupation on the buffer associated with said subsequences isbelow a predetermined threshold. This method enables the adding of stuffing data in a case not provided for by the MPEG-4 standard, for example, for a sequence encoded in the rectangular mode and having no (regularly coded) bi-directional images (B-frames).

The present invention relates to a method of encoding a sequence of digital images delivering a basic flow of encoded images and an improvement flow of encoded images, said flows being stored in a basic buffer and in an improvement buffer, respectively, said method comprising:
a step of distributing the images in said sequence between a first subsequence intended to form said basic flow and a second subsequence intended to form said improvement flow,
a step of evaluating a degree of occupation of one of the buffers at a current sampling instant.

It also relates to a digital image sequence encoder implementing such a method.

It also relates to a system for transmitting a sequence of digital images, comprising such an encoder.

It also relates to a computer program implementing such a method.

Finally, it relates to a signal transporting such a computer program.

It finds an application in particular in the real-time transmission of video data over a fluctuating-rate line, for example, an ADSL line having a rate varying between 256 kilobits per second (kbs) and 512 kbs.

With the development of the Internet, the exchange of video data has become widespread. In particular, applications involving the continuous and real-time transmission of video data (in English “streaming”) as well as video conferencing applications have developed greatly. In this context, video data compression standards adapted to the means and low rates are used, such as MPEG-4 (from the English “Moving Picture Expert Group”).

The video data compression standard MPEG-4 is based on a conventional predictive hybrid scheme for encoding video data. The images in the sequence forming said video data are encoded predictively with respect to each other, which justifies terming the method predictive. On the other hand, the movement and texture information for each image in said sequence with respect to the previous image is coded according to different techniques. The movement information is coded in the spatial domain in the form of movement vector fields whilst the texture is coded in the domain transformed by means of a block transformation such as DCT (from the English Discrete Cosine Transform), which justifies terming the scheme hybrid.

Such a scheme for encoding a sequence of digital images distinguishes three types of image:
images of the INTRA or I type, which are coded independently of the other images in said sequence,
images of the INTER P type, which are coded predictively with respect to an INTRA image or a previous INTER P image,
images of the bidirectional INTER B type, which are coded predictively both with respect to a previous image I or P and a following image I or P.

The images I are placed periodically in the sequence of images, the first image in a group of images always being an I. In the interval between two images I, images of the P or B type follow each other.

In the case of a fluctuating transmission channel, of the ADSL type, which guarantees a minimum rate of, for example, 256 kbs but may from time to time offer a bandwidth of 512 kbs, it is advantageous to provide a scalable encoding system, that is to say, one which delivers a basic flow and at least one improvement flow from one and the same input image sequence. The basic flow is encoded at the minimum rate supported by the transmission channel and yields a basic quality, whilst the improvement flow or flows supplement said basic flow in order to supply a decoded sequence of images of better quality. It should be noted here that the term “quality” is employed in the broad meaning of the term, meaning in our case that a better quality designates a greater frequency of images, a larger image format or a better visual quality. According to the bandwidth available for the transmission, the decoder receives the basic flow alone or the basic flow and the improvement flow or flows.

A video data compression standard such as MPEG-4 proposes various scalable encoding schemes. A coding scheme can in fact be scalable:
in terms of quality, that is to say the basic flow offers a basic visual quality over a certain number of encoded images and the improvement flow or flows improve the visual quality of the same number of images,
in spatial terms, that is to say the basic flow offers a basic format over a certain number of encoded images and the improvement flow or flows offer a superior format for the same number of images,
in temporal terms, that is to say the basic flow offers a certain number of images and the improvement flow or flows propose supplementary images which are interposed between those of the basic flow.

In the International Standards Organization document ISO/IEC 14496-2: 2001, entitled “Information Technology—Coding of Audiovisual Objects—Part 2: Visual”, Section 7.9.1, published on 31.1.01, it is specified how to decode scalable flows temporally in accordance with the MPEG-4 standard. On the other hand, said document does not state how an encoder should construct the basic and improvement flows, since only the decoding is normative. With regard to the encoder proper, information is however found in the document ISO/IEC JTC1/SC29/WG11, N1992, entitled “MPEG-4 Video Verification Model—Version 10.0”, in Section 3.8.2. It is indicated therein, for example, that an encoding scheme which is temporally scalable in accordance with the MPEG-4 standard can be organized as described in FIG. 1. Such a scheme comprises a basic flow (F₁) and a single improvement flow (F₂), as is generally the case. The images in the input sequence are for example, distributed evenly between the two flows, so that the basic flow and the improvement flow each offer a temporal frequency equal to one half of that of the input digital image sequence.

For a video transmission application in real time the encoding system must also monitor the rates of occupation over time of a basic buffer (T₁) associated with the basic flow (F₁) and of an improvement buffer (T₂) associated with the improvement flow (F₂). These buffers serve to store the encoded images before they are transmitted to a decoder via a transmission channel. As the encoding takes place, if the encoding rate is greater than the transmission rate, said memories fill up more quickly than they empty. There is even a risk that they may overflow, which should never happen in order to guarantee correct functioning of the complete system consisting of encoder, transmission channel and decoder. If on the other hand the rate of encoding of a flow, for example the improvement flow, is very low, in any event less than the transmission rate, the improvement buffer (T₂) may empty, which would cause a serious malfunctioning of said system, since the decoder would no longer receive any data.

It should be noted in this regard that the functioning of a buffer such as the basic buffer (T₁) or the improvement buffer (T₂) is specified by a normative model, which guarantees that an encoder will produce flows in accordance with the MPEG-4 standard.

The occupation levels of the buffers associated with the basic and improvement flows are therefore evaluated at each current instant (t) of sampling the input image sequence. If an image (Im(t)) intended for the flow (Fᵢ), i being equal to 1 or 2, is intended to be decoded at the current instant (t), the degree of occupation of the buffer (Tᵢ) associated with said flow is evaluated once said image has been stored therein. If said level passes a predetermined threshold (which may be equal to 100%), it is generally decided not to encode said image in this flow.

If on the contrary provision is not made for storing any image at the current instant (t) in a buffer (Tᵢ), whilst said buffer threatens to be completely empty at said instant, the MPEG-4 standard gives the possibility of adding to the flow (Fᵢ) special data known as stuffing data. Such stuffing data are placed subsequent to the information relating to an encoded image belonging to said flow, for example, the last image stored in the buffer (Tᵢ) at a previous instant.

However, adding such stuffing data in a flow of the MPEG-4 type at the level of an image is allowed only under very precise conditions, which are that said image to which it is wished to add said data has been encoded:
either in the “sprite” mode, that is to say in a very particular mode where a mosaic image grouping together all the views of the images in the same scene is encoded separately and each image in this scene is encoded simply by its position in said mosaic,
or in the “binary” or “binary shape” mode, that is to say modes in which the contour (or “shape”) of objects in the scene and their texture are encoded separately,
or in the bidirectional mode B, that is to say in a mode where the use of bidirectional images B is allowed.

These conditions are specified in the above-mentioned document from the International Standards Organization ISO/IEC 14496-2: 2001, entitled “Information Technology—Encoding of Audiovisual Objects—Part 2: Visual”, Section 6.2.3, published on 31.1.01.

For applications involving the transmission of video data in real time, the “sprite” mode is excluded, since it is too complex. As for the modes which use the shape of the objects, they are for the moment rarely used for real-time applications because of their complexity and in particular the need for a prior segmentation of the objects with respect to the background of the images. Consequently, for the most conventional case of rectangular images, the only mode which makes it possible to use stuffing data is therefore the bidirectional mode.

It should, however, be noted that the use of bidirectional images is not favorable to all applications. Bidirectional images are certainly encoded very effectively, but they also introduce a complexity and a delay into the encoding and decoding processes, which is not always desirable, in particular for real-time applications at low rate.

In the case of an application in the rectangular mode where bidirectional images are not used, the MPEG-4 standard therefore does not allow the use of stuffing data. There therefore does not exist a known means for preventing malfunctioning of the complete system consisting of encoder, transmission channel and decoder due to the temporary non-occupation of one of the buffers.

The object of the present invention is to propose a method of encoding a sequence of digital images making it possible to prevent a buffer associated with one of the basic or improvement flows from emptying during the encoding of said sequence of images.

This object is achieved by the method as described in the introductory paragraph and is characterized in that:
said method also comprises a step of creating a bidirectional image in one of the subsequences, able to create a notional bidirectional image between two successive instants of the input image sequence, intended to receive stuffing data, when the degree of occupation of the buffer associated with said subsequence is below a predetermined threshold.

The advantage of such a method is firstly that it enables the use of stuffing data in a case not provided for by the MPEG-4 standard, for example, for a sequence encoded in the rectangular mode and with no bidirectional images. These conditions, the most simple possible, are very often adopted for applications involving the transmission of video data in real time and at a low rate.

In this type of application, although this is not provided for by the MPEG-4 standard, it is in practice not rare for a buffer associated with a flow of encoded images to threaten being emptied. This is because the images in an input sequence are generally distributed between the basic and improvement flows so that the basic flow supplies a rate corresponding to the minimum rate guaranteed by the transmission channel. In this case, the improvement flow supplements the basic flow by providing an additional rate lying between the minimum guaranteed rate and the maximum rate offered by the transmission channel. It can therefore fairly easily be imagined that the distribution of the images in the input sequence between the basic and improvement flows can vary according to the content of the image sequence and for example its complexity. It is even possible to envisage an extreme case in which the sequence temporarily becomes very simple and inexpensive to encode and where all the images are encoded in the basic flow, for example in the case of a completely static scene.

The method according to the invention also has the advantage of being well adapted to the case in which it is not possible to predict when a new image will be stored in a buffer and, therefore, when the filling rate of said memory will increase. It has the advantage of allowing rapid reaction to an urgent problem: if a buffer is on the point of becoming completely empty at a current instant, a notional bidirectional image is created at a sampling instant prior to the current instant and stuffing data are stored therein. Said bidirectional image can be placed between two successive instants of sampling of the input image sequence, that is to say at an instant not yet occupied by an encoded image in one of the flows. It should be noted in fact that, for one and the same input image sequence, it is absolutely not possible to allocate two images to the same sampling instant. To do this, there is allocated to the improvement flow a temporal frequency greater than that of the input image sequence, so as to reserve, with certainty, available sampling instants in order to accept therein any notional bidirectional images.

In the preferred embodiment of the invention, the method is also characterized in that an image frequency double the input image sequence is allocated to the second subsequence, so that it can receive notional bidirectional images. The simplest solution and nevertheless a sufficient one is in fact simply providing a free sampling instant between two sampling instants in the input image sequence.

Another object of the present invention is an encoder for an input digital image sequence for implementing said method, in an integrated circuit for example, using hardware or software means.

The invention will be further described with reference to embodiments shown in the drawings to which, however, the invention is not restricted.

FIG. 1 describes the distribution of the images in the input sequence between the basic flow and the improvement flow according to the state of the art,

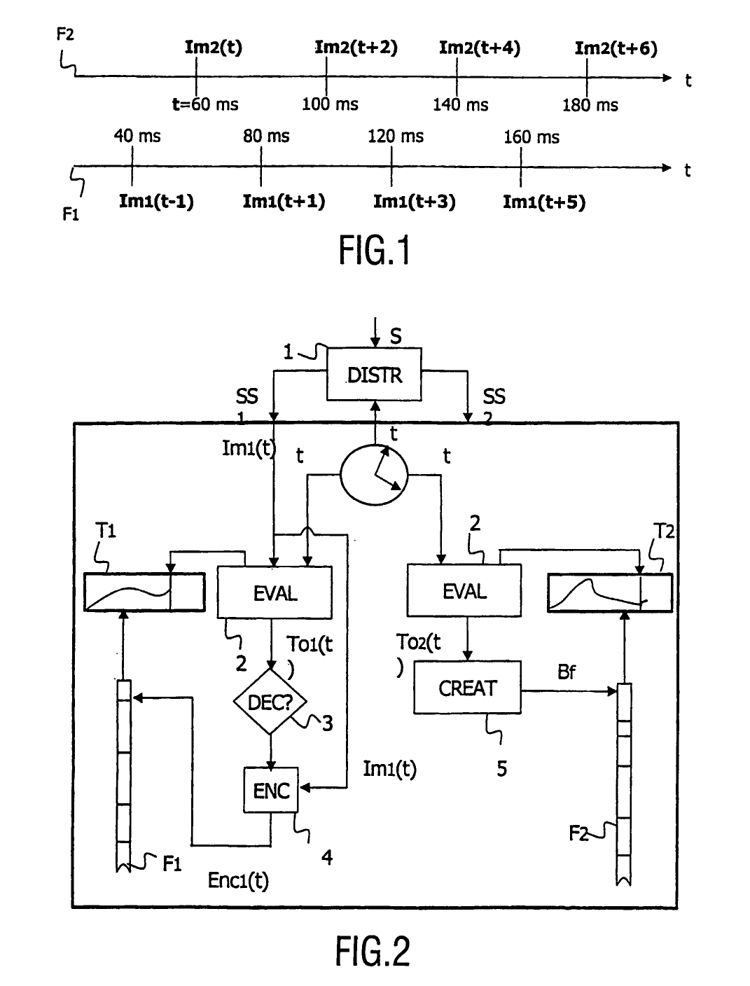

FIG. 2 is a block diagram of a method of encoding an image sequence according to the invention,

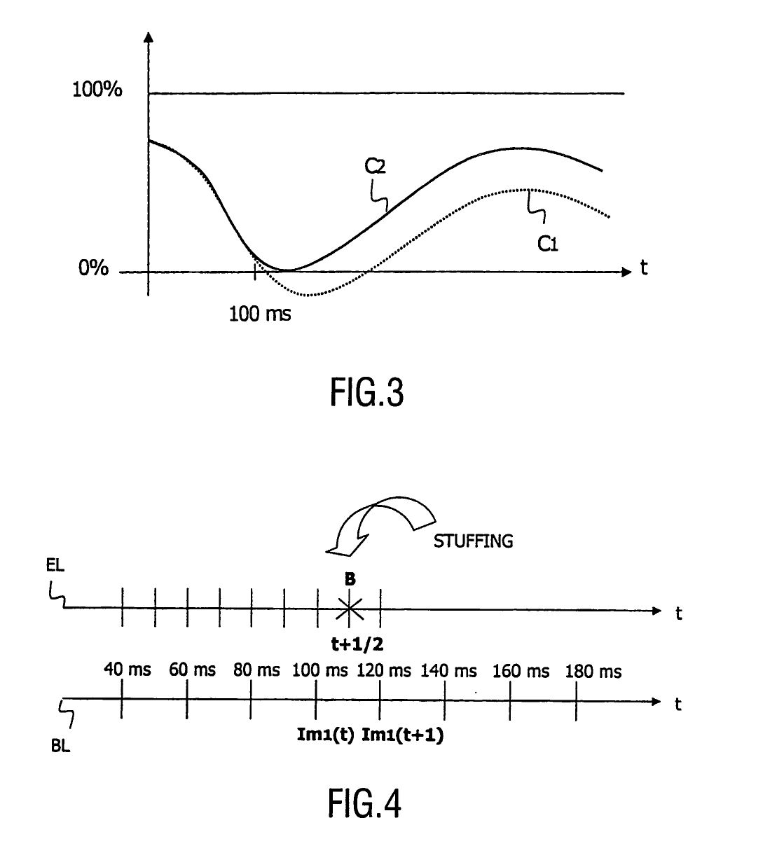

FIG. 3 presents two examples of curves for the change in the degree of occupation of a buffer during the encoding of an image sequence,

FIG. 4 describes the step of creating a bidirectional image according to the invention.

The invention relates in particular to a method of encoding a digital image sequence for applications involving the transmission of video data in real time on a fluctuating-rate transmission channel, for example a line of the ADSL type whose rate varies between 256 and 512 kbs.

The coding technique used is in our example the MPEG-4 standard, but can also be any other standard supporting a temporal scalability scheme.

FIG. 2 depicts a block diagram summarizing the functioning of a method of encoding an input image sequence (S) according to the invention. As in the state of the art, said method comprises a step (1) of a priori distribution DISTR of the images in said sequence (S) between a first subsequence (SS₁) intended to form a basic flow (F₁) and a second subsequence (SS₂) intended to form an improvement flow (F₂). It should however be noted that the images in the sequence (S) are not necessarily distributed equitably and evenly between the two subsequences and that this distribution is liable to be modified during the encoding process.

In the preferred embodiment of the invention, the majority or even all the images in the sequence (S) are a priori allocated to the first subsequence (SS₁) and therefore intended for the basic flow (F₁). In this case, said basic flow (F₁) is therefore provided with a temporal frequency equal to that of the input image sequence (S).

The method according to the invention also comprises a step (2) of evaluating EVAL a degree of occupation (To₁(t), To₂(t)) of one of the buffers (T₁, T₂) at a current sampling instant (t). In other words, the degrees of occupation of the buffers (T₁, T₂) are evaluated at each input sequence sampling instant (t) so as to ensure that said memories do not overflow or empty completely;

Two cases generally arise:
a. an image (Im(t)) associated with the current sampling instant (t) is on the point of being encoded and then stored in the buffer (Tᵢ), i being equal to 1 or 2,
b. no image must be stored in the buffer (Tᵢ) at the current sampling instant (t).

The first case corresponds to the example of the image (Im₁(t)) in FIG. 2, which is intended for the basic flow and therefore for the basic buffer (T₁). The evaluation step EVAL (2) then consists of estimating the degree of occupation (To₁(t)) of the basic buffer (T₁) once the encoded current image (Enc₁(t)) has been stored therein at the current sampling instant (t). Such an evaluation is based on:
the degree of occupation (To₁(t−1)) of said buffer memory at the past sampling instant (t−1),
the transmission rate for calculating to what extent the buffer has emptied between the sampling instants (t−1) and (t), in other words the rate of emptying (V_{d}(t−1, t)) of said memory,
the memory space necessary (B(Im(t))) for effectively storing the encoded current image (Enc₁(t)). Given an encoding rate which it is wished to apply to the current image sequence, there is derived therefrom a total budget of bits for the entire sequence. This budget can be distributed between the images of said sequence in different ways:
   either the same average budget is allocated to all the images in the sequence,
   or a budget personalized to an image in the sequence is calculated according to the encoding rate and parameters related to said image such as an evaluation of its complexity. If the image is considered to be complex, it is concluded that it requires a personalized budget greater than the average budget in order to ensure sufficient quality of the encoded image. On the other hand, if the image is considered to be of low complexity, a personalized budget less than the average budget is allocated to it.

The budget (B(Im(t))) calculated for the image (Im₁(t)) is added to the new value of the degree of occupation of the buffer (T₁) at the current instant (t) in order to give an estimation of the degree of occupation (To₁(t)) of the said memory once the encoded image Enc1(t) has been stored therein. In summary, the new value of the degree of occupation of the buffer (T₁) at the current instant (t) is expressed as follows:
Toᵢ(t)=To₁(t−1)−V_{d}(t−1, t)+B(Im(t))

Said step (2) of evaluation EVAL of the degree of occupation (To₁(t)) of the buffer at the current sampling instant (t) is logically followed by a decision step DEC (3) which decides, according to said degree of occupation (To₁(t)), whether said image (Im(t)) must be encoded or not. If the degree is higher than a predetermined threshold (which may be 100% or a lower value if a margin of error is granted to the number of bits necessary for encoding the current image (Im(t)), it is decided not to encode the current image (Im1(t)) in the basic flow. It may then be decided to reallocate said image to the improvement flow, where it will perhaps be effectively encoded according to the degree of occupation of the improvement buffer at the same current sampling instant (t).

If on the other hand the decision step DEC (3) decides that the current image Im(t) in the subsequence (SS₁) should be encoded, said image is subjected to the encoding process ENC (4) proper, which delivers an encoded image Enc₁(t), stored in the buffer (T₁) for which it is intended. The image (Enc₁(t)) in the flow (Fᵢ) is then transmitted to the decoder via a transmission channel.

It should be noted that the combination of the step EVAL (2) of evaluating the degree of occupation and the decision step DEC (3) constitutes what is normally referred to as an encoding rate regulation system.

In the second case, no encoded image is intended to be stored in the buffer at the current sampling instant; this corresponds in FIG. 2 to the improvement buffer (T₂). The step EVAL (2) of evaluating the degree of occupation (To2(t)) of said memory consists simply of calculating the change in the degree of occupation of said memory at the past instant (t−1) according to the transmission rate.

If said degree is less than a predetermined threshold, in other words if the buffer (T₂) threatens to empty, as shown by the curve (C₁) in FIG. 3, whereas no image is to be stored therein at the current sampling instant (t), the method according to the invention proposes the following solution, described by FIG. 4, which consists of creating a notional bidirectional image B at the sampling instant close to (t), intended to receive stuffing data. Said method, therefore also comprises a bidirectional image creation step CREAT (5) as shown in FIG. 2. Such an artifice is made possible by two conditions:
a. A temporal frequency greater than that of the input image sequence has been provided at the start of the encoding process for the improvement flow so as to provide free sampling instants in order to store therein any additional images. It should be noted in fact that it is absolutely not possible to have more than one image per sampling instant in sampled flows coming from the same input image sequence. In the preferred embodiment of the invention, a temporal frequency double the temporal frequency of the input image sequence is allocated to the improvement flow, that is to say the notional bidirectional image could for example, be placed at the instant t−½.
b. Said notional bidirectional image (B_{f}) has a particular status in the context of the MPEG-4 standard, in the sense that it is considered to be “not coded”. This image contains no data and, from the point of view of the decoder, it is an exact copy of the previous displayed image. The syntax of the MPEG-4 standard makes it possible to allocate to said image (B_{f}) as many stuffing data as necessary to satisfy the filling constraints for the buffer (T₂). As shown by the curve (C₂) in FIG. 3, the buffer (T₂) is prevented from emptying and causing malfunctioning of the complete system consisting of encoder, transmission channel and decoder.

As has just been seen, the method according to the invention has the advantage of proposing an immediate and effective solution for preventing a buffer associated with a flow of encoded images from emptying. Such a method is particularly advantageous in cases where the MPEG-4 standard has not provided for the use of stuffing data, for example for applications in real time and at low rate where:
the rectangular mode is used for its simplicity,
it is not wished to use bidirectional images since they are too complex,
at least two sampled flows are created in order to adapt to a fluctuating-rate transmission channel,
it is not possible to predict at which instant an image will be stored in a buffer since the images according to the flows are distributed in real time in order to best exploit the transmission rate. This is often the case with the improvement buffer.

The present invention can be implemented in the form of software loaded in one or more circuits implementing the previously described method of encoding a sequence of digital images, or in the form of integrated circuits. The device for encoding an input image sequence corresponding to said method repeats here the functional blocks in FIG. 2. It comprises:
means (DISTR) (1) of distributing images in said sequence between a first subsequence (SS₁) intended to form said basic flow (F₁) and a second subsequence (SS₂) intended to form said improvement flow (F₂),
means EVAL (2) of evaluating one of the degrees of occupation (To₁(t), To₂(t)) of one of the buffers (T₁, T₂) at a current sampling instant (t),
means CREAT (5) of creating a bidirectional image in one of the subsequences (SS₁, SS₂), able to create a notional bidirectional image (B_{f}) between two successive instants in the input image sequence, intended to receive stuffing data, when the degree of occupation of the buffer associated with the said subsequence is below a predetermined threshold.

There are many ways of implementing the previously mentioned functions by means of software. In this regard, FIG. 2 is highly schematic. Therefore, although it shows several functions in the form of several blocks, this does not exclude a single software package performing several functions. Nor does this exclude a single function being able to be performed by a set of software packages. It is possible to implement these functions by means of a video encoder circuit, said circuit being suitably programmed. A set of instructions contained in a program memory can cause the circuit to perform the various operations described above with reference to FIG. 2. The set of instructions can also be loaded in the programming memory by reading a data medium such as, for example, a disk which contains the set of instructions. The reading can also be carried out by means of a communication network such as, for example, the Internet. In this case a service provider will make the set of instructions available to interested parties.

No reference sign between parentheses in the present text should be taken limitingly. The verb “comprise” and its conjugations does not exclude the presence of elements or steps other than those listed in a sentence. The word “a” or “one” preceding an element does not exclude the presence of a plurality of these elements or steps.

1. A method of encoding a sequence of digital input images (S) delivering a basic flow (F₁) of encoded images and an improvement flow (F₂) of encoded images, said flows being stored respectively in a basic buffer (T₁) and in an improvement buffer (T₂), said method comprising:
a step (1) of distributing the images in said sequence between a first subsequence (SS₁) intended to form said basic flow (F₁) and a second subsequence (SS₂) intended to form said improvement flow (F₂),
a step (2) of evaluating a degree of occupation (To₁(t), To₂(t)) of one of the buffers (T₁, T₂) at a current sampling time (t),
characterized in that:
said method also comprises a step of creating a bidirectional image (5) in one of the subsequences (SS₁, SS₂), able to create a notional bidirectional image (B_{f}) between two successive instants of the input image sequence, intended to receive stuffing data, when the degree of occupation of the buffer associated with said subsequence is less than a predetermined threshold.

2. A method of encoding a digital image sequence (S) as claimed in claim 1, characterized in that an image frequency double the input image sequence is allocated to the second subsequence (SS₂), so that it can receive notional bidirectional images.

3. An encoder for a digital image sequence (S) delivering a basic flow (F₁) of encoded images and an improvement flow (F₂) of encoded images, said flows being stored respectively in a basic buffer (T₁) and in an improvement buffer (T₂), said device comprising:
means (1) of distributing images in said sequence between a first subsequence (SS₁) intended to form said basic flow (F₁) and a second subsequence (SS₂) intended to form said improvement flow (F₂),
means (2) of evaluating a degree of occupation (To₁(t), To₂(t)) of one of the buffers (T₁, T₂) at a current sampling time (t),
characterized in that:
said device also comprises means (5) of creating a bidirectional image in one of the subsequences (SS₁, SS₂) able to create a notional bidirectional image (B_{f}) between two successive times in the input image sequence, intended to receive stuffing data, when the degree of occupation of the buffer associated with said subsequence is below a predetermined threshold.

4. An encoder for a digital image sequence (S) as claimed in claim 3, characterized in that it comprises means adapted to allocate an image frequency double the input image sequence to the second subsequence (SS₂), so that it can receive notional bidirectional images.

5. A system for transmitting a digital image sequence (S), comprising an encoder as claimed in claim 3 able to process said sequence of digital images and to transmit them via a transmission channel to a decoder.

6. A computer program for encoding a digital image sequence comprising a set of instructions which, when it is loaded in a circuit of said encoder, causes the latter to implement the method as claimed in claim 1.

7. A signal intended to transport a computer program as claimed in claim 6.
